(19) United States
(12) Patent Application Publication
(10) Pub. No.: US 2023/0048056 A1
(43) Pub. Date: Feb. 16, 2023

(54) METHOD FOR DESCRIBING POWER OUTPUT OF A CLUSTER OF WIND AND SOLAR POWER STATIONS CONSIDERING TIME-VARYING CHARACTERISTICS

(71) Applicant: DALIAN UNIVERSITY OF TECHNOLOGY, Dalian (CN)

(72) Inventors: Jianjian SHEN, Dalian (CN); Yue WANG, Dalian (CN); Chuntian CHENG, Dalian (CN); Lin HU, Dalian (CN); Xiufeng LI, Dalian (CN)

(21) Appl. No.: 17/883,126

(22) Filed: Aug. 8, 2022

(30) Foreign Application Priority Data
Aug. 9, 2021 (CN) 202110906595.7

(51) Int. Cl. G06F 30/20; H02J 3/38; H02J 3/46

(52) U.S. Cl. CPC G06F 30/20; H02J 3/381; H02J 3/466; H02J 2300/24; H02J 2300/28; H02J 2203/20; G06F 2111/10

(57) ABSTRACT

A method for describing power output of a cluster of wind and solar power stations considering time-varying characteristics. The error function is employed to characterize the degree of difference in power output within periods, and split-level clustering is used to determine the optimal period division under different period division quantities. The economic efficiency theory is introduced to determine the ideal number of periods, avoiding the randomness and unreasonableness that may result from relying on the subjective determination of the number of clusters. This method can reasonably divide the wind and solar power output period, fully reflecting the time-varying law of wind and solar power generation. The results also can accurately reflect the distribution characteristics of the power output of the power station group at each time period, and the power output each time period shows better reliability, concentration, and practicality.

### TECHNICAL FIELD

The present invention relates to the field of power system dispatching, and in particular to a method for describing power output of a cluster of wind and solar power stations considering time-varying characteristics.

### BACKGROUND

The rapid development of new energy makes the wind and solar and other intermittent energy in the power system account for an increasing proportion, limited by wind power, photovoltaic power inherent intermittent, uncontrollable power generation characteristics, as well as other comprehensive factors, new energy consumption problems have been very prominent, especially with the rapid expansion of grid-connected scale, abandoned wind, abandoned solar and a high proportion of clean energy system stability and operation of the problem of increasing impact. From the time scale analysis, the time-varying uncertainty of the new energy generation process is one of the main problems that restrict its large-scale consumption. The larger the scale of grid connection, the greater the demand for flexible regulation caused by deviations in wind and solar power prediction, especially the demand for load valley and peak balance, and the greater the risk of stable system operation.

The current research on the quantification of uncertainty in wind and solar power generation processes can be broadly classified into scenario simulation and uncertainty aggregation, with the former belonging to the category of stochastic optimization and the latter to the category of robust optimization. For scenario simulation, on the one hand, the distribution characteristics of wind and solar power can be studied directly, but a large amount of raw data is required to obtain accurate probability distributions. On the other hand, scenario analysis is used to discretize random vectors of continuous probability distributions into sets of scenarios, thus converting stochastic optimization into deterministic problems. The key to describing the uncertainty of wind and solar power generation based on scene analysis is how to improve the approximation of the scene set to the original problem and the computational efficiency of generating a high-quality scene set. For the uncertainty set method, the robust optimization model can be constructed to give the construction method of the uncertainty set of new energy generation, and the economy and safety balance of the robust optimization decision can be effectively controlled by adjusting the set boundary. In addition, the uncertainty of the new energy generation output can also be described by using the polyhedral ensemble in robust optimization. It should be noted that the key to constructing the output uncertainty set is how to select the robust set to ensure the rationality of the decision result.

Given the above problems, the invention proposes a method for describing the output power of a cluster of wind and solar power stations considering time-varying characteristics and tests its application in the engineering context of the Yunnan power grid. The results show that the invention can reasonably divide the output period of the wind and solar power station, fully reflecting the time-varying law of wind and solar power generation, and the output in each period presents better reliability, concentration and practicality.

### SUMMARY

The technical problem to be solved by the present invention is to provide a method for describing the power output of wind and solar power cluster considering time-varying characteristics, to accurately describe the power output process of wind and solar power plants and improve the reliability, concentration, and practicality of uncertain power output description of wind and solar power plants.

Technical solutions of the invention.

A method for describing power output of a cluster of wind and solar power stations considering time-varying characteristics, characterized in that it includes the following steps.

(1) For the problem of dividing the period of the daily output process of wind and solar power clusters, the output error function is used as the evaluation criterion for the period division, so that the output characteristics of the group of wind and solar power in the same period tend to be consistent, and the calculation formula is as follows.

$$\{ \begin{matrix}F = {\sum }_{k = 1}^{K} {F}_{{t}_{k - 1} , {t}_{k}} \\ {F}_{{t}_{k - 1} , {t}_{k}} = {\sum }_{t = {t}_{k - 1}}^{{t}_{k}} {\sum }_{d = 1}^{D} {( {p}_{t , d} - {p}_{d , {t}_{k - 1} - {t}_{k}}^{a v g} )}^{2} / D \\ {p}_{d , {t}_{k - 1} - {t}_{k}}^{avg} = \frac{1}{{l}_{k}} {\sum }_{t = {t}_{k - 1}}^{{t}_{k}} {p}_{t , d} \\ {p}_{t , d} = \frac{{P}_{t , d}}{{P}_{C}}\end{matrix} \qquad ( 1 )$$

where F indicates the value of the output error function, the larger the value of the output error function, the worse the time division effect, the smaller the value of the output error function, the better the time division effect; K is the number of time slots; tₖ₋₁, tₖ indicates the node of the time interval division; Fₜ_{_{k−1,}}ₜ_{ₖ} indicates the sum of squared errors in the output data of the cluster of wind and solar power at each moment in time period tₖ₋₁−tₖ, a larger Fₜ_{_{k−1,}}ₜ_{ₖ} indicates a larger difference in the output data of the cluster of wind and solar power in that time period, and vice versa; D is total number of days of the extracted wind and solar power plant group output data; d indicates the d th day; P_{t,d} indicates the output rate of the cluster of wind and solar power at the tth moment of the d th day; P_{d,t}_{_{k−1,}}₋ₜ_{ₖ}^{avg} indicates the average value of the output rate of the wind and solar power group at each moment in time period tₖ₋₁−tₖ on the d th day; lₖ indicates the number of sampling points in time period tₖ₋₁−tₖ; P_{t,d} indicates the output of the cluster of wind and solar power at the tth moment of the d th day, MW; P_{c} is total installed capacity of wind and solar power station cluster, MW.

(2) For the problem of optimal splitting nodes under the number of daily power output processes of the wind and solar power cluster at any time division, a splitting hierarchical clustering-based time division method is constructed, and the actual power output process of each wind and solar power cluster is used as the feature input, and the optimal time division is determined by hierarchical splitting with this power output error function as the evaluation criterion; the specific steps are as follows.

step 1. input the actual power output process sequence of each wind and solar power cluster.

Step 2. iterate through the output of each period in a day, divide the 24 h of the day into two segments, and calculate the value of this output error function corresponding to all tall-times according to Equation (1), and the result is expressed as the following equation.

[F_{0-1-T}²,F_{0-2-T}², . . . F₀₋ₜ_{₂}_{-T}², . . . F_{0-(T-1)-T}²] (2)

where F₀₋ₜ_{₂}_{-T}² indicates the value of this outgoing error function when dividing a day into two segments 0−t₂ and t₂−T; T is the number of sampling points, when sampling in hourly steps, T=24; when sampling in 15-minute steps, T=96;

step 3. identify the minimum value of the output error function when the number of divided periods is 2.

$${F}_{min}^{2} = {min}_{{t}_{2} = 1 , 2 , ⋯ , T - 1} {F}_{0 - {t}_{2} - T}^{2} \qquad ( 3 )$$

assuming that the time slot split node corresponds to Fₘᵢₙ² is (0−t₂*, t*−T), the day is divided into 2 segments, noted as t, after the first level of splitting.

step 4. Traverse 0−t* and t₂*−T within each time out, as t₃ may be located in 0−t₂* or t₂*−T time, so there will be two types of cases: (0−t₂*, t₂*−t₃, t₃−T) or (0−t₃, t₃−t₂*, t₂*−T), at this time by the following formula to determine the optimal split node.

$${F}_{min}^{3} = min \{ \begin{matrix}{min}_{{t}_{3} = 1 , 2 , ⋯ , {t}_{2}^{*} - 1} {F}_{0 - {t}_{3} - {t}_{2}^{*} - T}^{3} \\ {min}_{{t}_{3} = {t}_{2}^{*} + 1 , ⋯ , T - 1} {F}_{0 - {t}_{2}^{*} - {t}_{3} - T}^{3}\end{matrix} \} \qquad ( 4 )$$

assuming that the time slot split nodes corresponding to Fᵣ are t* and t* in that order, the day is divided into 3 segments, noted as (0−t₂*, t₂*−t₃, t₃*−T), after the second level of splitting.

step 5. In accordance with step 4, the optimal segmentation nodes and the corresponding minimum value [Fₘᵢₙ¹, Fₘᵢₙ², . . . Fₘᵢₙ^{T},] of this output error function under different period division quantities is obtained in turn, until the maximum period division quantity reaches T.

(3) to determine the optimal number of time slots for the daily output process of the wind and solar wind and solar power cluster, the output efficiency index is used as a criterion, and the number of time slots corresponding to the maximum output efficiency index is taken as the final number of time slots; the specific steps are as follows.

step 1. define revenue as the degree of reduction of this output error function and cost as the degree of increase of the time slot division quantity, calculated as follows.

$${ε}_{n} = \frac{{F}_{max} - {F}_{min}^{n}}{{F}_{max} - {F}_{min}} {δ}_{n} = \frac{n - {n}_{min}}{{n}_{max} - {n}_{min}} \qquad ( 5 )$$

where εₙ indicates the degree of decrease of this output error function when the number of time slots is n; δₙ indicates the degree of increase of the number of time slots when the number of time slots is n; Fₘₐₓ and Fₘᵢₙ indicate the maximum and minimum values of this output error function, Fₘₐₓ=max(Fₘᵢₙ¹, Fₘᵢₙ², . . . , Fₘᵢₙ^{T}), Fₘᵢₙ=min(Fₘᵢₙ¹, Fₘᵢₙ² . . . , Fₘᵢₙ^{T}), respectively; nₘₐₓ and nₘᵢₙ indicate the maximum and minimum values of the number of time slots, nₘₐₓ=T, nₘᵢₙ=1, respectively.

step 2. calculate the benefits under different time division quantities of the daily output process of the wind and solar power plant cluster according to the revenue and cost, the formula is as follows.

eₙ=εₙ−δₙ (6)

step 3. Find the number of time period n* corresponding to the maximum benefit as the final number of periods.

(4) For the problem of uncertain power output description of the wind and solar power plant cluster, the kernel density estimation method is used to establish the probability distribution of the power output of the wind and solar power cluster for each period; the method is a nonparametric method used to estimate the probability density function, x₁, x₂, . . . , xₙ is n samples of the random variable X, and let its probability density function ƒₕ(x) be:

$${f}_{h} ( x ) = \frac{1}{n h} {\sum }_{i = 1}^{n} K ( \frac{x - {x}_{i}}{h} ) \qquad ( 7 )$$

where h is the smoothing parameter, also known as bandwidth; K [symbol] is the kernel function, and the most commonly used Gaussian kernel function is chosen; mathematical theory proves that ƒₕ (x) will inherit the continuity and differentiability of K [symbol] , and if the Gaussian kernel function is chosen, ƒₕ(x) can be differentiated to any order; the n samples p1, p2, . . . , pn of the output rate P_{t,d} of the wind and solar power are brought into the above equation (7), and the corresponding The probability density function ƒₕ (p) of the power output of the wind and solar power plant cluster.

The beneficial effect of the present invention: compared with using a single probability distribution function to accurately describe the output process of wind and solar power clusters, establishing multiple differential probability density distribution functions in periods can apply the time-varying law of the output process of a cluster of wind and solar power plants to accurately describe the uncertain output of wind and solar power. The output error function essentially refers to the difference of the output data in each period, and the optimal period division is determined by minimizing the value of the output error function so that the output characteristics in the same period tend to be the same. The introduction of economic benefits to determine the number of time slots divided avoids the randomness and unreasonableness of relying on subjectivity to determine the number of time slots. The kernel density estimation is used to establish the probability distribution of the power output of the wind and solar power cluster at each time, avoiding the influence of the parameter estimation method on the results due to the choice of distribution shape, and the results obtained can accurately reflect the distribution characteristics of the power output of the wind and solar power cluster at each time.

### DESCRIPTION OF DRAWINGS

FIG. 1 is a diagram of the general solution framework of the method of the invention.

FIG. 2 shows the schematic diagram of the time slot division method.

FIG. 3 shows a schematic diagram for determining the number of periods to be divided.

FIGS. 4(a) and 4(b) show the reliability and concentration of the power output description of the wind power plant complex.

FIGS. 5(a) and 5(b) show the reliability and concentration of the power output description of the PV plant cluster.

FIGS. 6(a) and 6(b) show the reliability and concentration of the hybrid wind and solar power cluster output description.

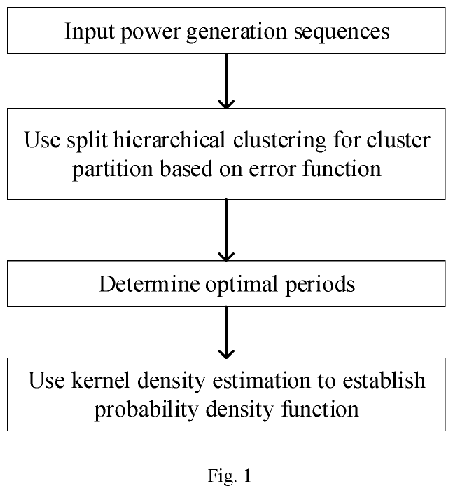

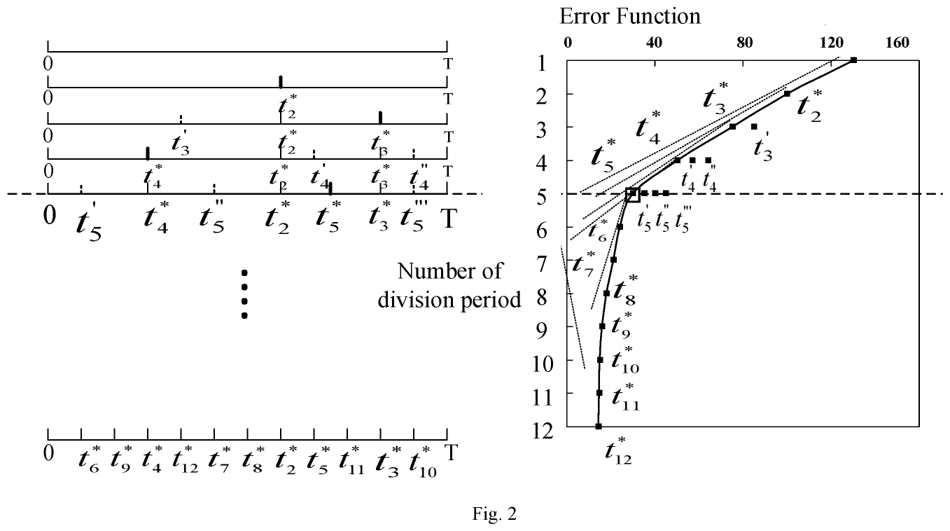

### DETAILED DESCRIPTION

The specific embodiments of the invention are further described below in conjunction with the accompanying drawings and technical solutions.

The invention adopts the probability density distribution function to describe the power output of the wind and solar power cluster, considering that the power generation of the wind and solar power is greatly affected by the weather, and its intra-day power output process usually shows a certain time-varying law. For example, wind power is large at night and small during the day, and photovoltaic power is large at noon and small in the early morning and evening. In this case, using a single probability distribution function may not accurately describe the power output process of wind and solar power. Therefore, the present invention introduces the time-varying characteristics into the output description function, and establishes multiple differential probability density distribution functions through a reasonable division of periods.

The present invention divides the daily output process of the wind and solar power cluster into different periods, with the purpose of making the output characteristics in the same period converge as much as possible, to construct an accurate output distribution function. For this purpose, the output error function is introduced to establish the evaluation criterion for the period division.

$$\{ \begin{matrix}F = {\sum }_{k = 1}^{K} {F}_{{t}_{k - 1} , {t}_{k}} \\ {F}_{{t}_{k - 1} , {t}_{k}} = {{\sum }_{t = {t}_{k - 1}}}^{{t}_{k}} {{\sum }_{d = 1}}^{D} {( {p}_{t , d} - {p}_{d , {t}_{k - 1} - {t}_{k}}^{avg} )}^{2} / D \\ {p}_{d , {t}_{k - 1} - {t}_{k}}^{avg} = \frac{1}{{l}_{k}} {{\sum }_{t = {t}_{k - 1}}}^{{t}_{k}} {p}_{t , d} \\ {p}_{t , d} = \frac{{P}_{t , d}}{{P}_{C}}\end{matrix} \qquad ( 8 )$$

where F indicates the value of the output error function, the larger the value of the output error function, the worse the time division effect, the smaller the value of the output error function, the better the time division effect. K indicates the number of periods divided; tₖ₋₁,tₖ indicates the nodes of periods divided; Fₜ_{_{k−1,}}ₜ_{ₖ} indicates the error sum of squared power output data of the group of wind and solar power plants at each moment in period tₖ₋₁−tₖ, the larger Fₜ_{_{k−1,}}ₜ_{ₖ} is, the greater the difference of power output data of the group of wind and solar power plants in that period is, and vice versa. D is the total number of days of the extracted wind and solar power cluster output data; d indicates d th day; P_{t,d} indicates the output rate of the wind and solar power cluster at the d th moment of day t; P_{d,t}_{_{k−1}}₋ₜ_{ₖ}^{avg} indicates the average value of the output rate of the wind and solar power cluster at each moment in time period tₖ₋₁−tₖ of dth day; lₖ indicates the number of sampling points in the time period tₖ₋₁−tₖ; P_{t,d} indicates the output rate of the wind and solar power cluster at the tth moment of d th day, MW; P_{c} is the total installed capacity of the wind and solar power, MW.

The value of the outgoing error function is closely related to the way the time period is divided, which is essentially a multivariate function of the split node t₁, t₂ . . . t_{K-1}. Generally, the smaller the output error function, the better the segmentation method, the higher the accuracy of the corresponding output probability distribution function, but from the engineering practicality consideration, the more the output description function, the more complexity and difficulty in using it. Therefore, a suitable number of segments needs to be selected to effectively balance accuracy and practicality. The following section determines the optimal segmentation in two main parts, the first part is to determine the optimal segmentation node for any number of segments, and the second part is to determine the optimal number of segments based on the variation of the output error function with respect to the number of segments.

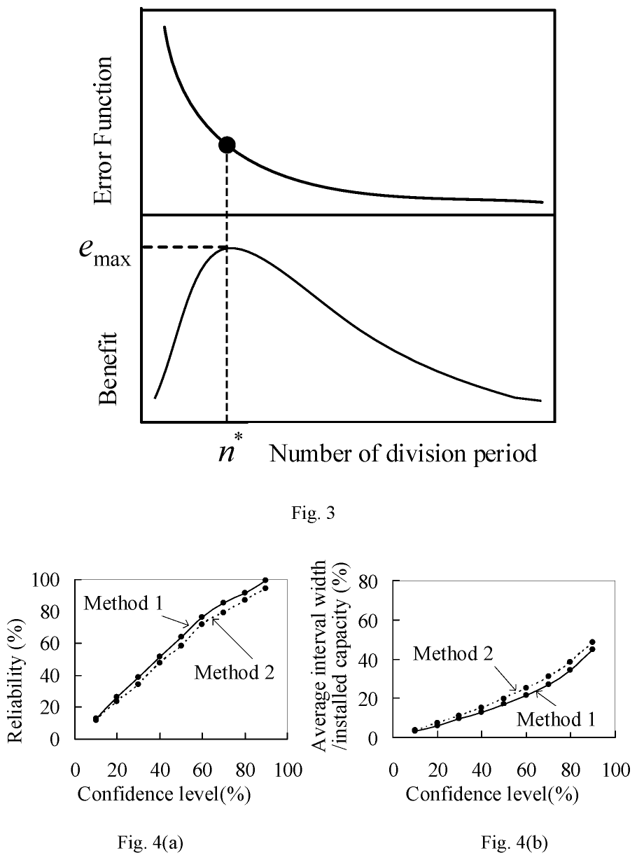

In order to determine the optimal split node for any number of segments, the invention constructs a method for dividing time slots based on split hierarchical clustering, using the output error function as the evaluation criterion, and determines the optimal time slot division through hierarchical splitting, the principle of which is shown in FIG. 3. The specific idea is to first traverse each moment of the day, the day 24 h into two time periods, according to the formula (8) to calculate all the time nodes corresponding to the value of the output error function, the results can be expressed as the following formula.

[F_{0-1-T}²,F_{0-2-T}², . . . F₀₋ₜ_{₂}_{-T}², . . . F_{0-(T-1)-T}²] (9)

where F₀₋ₜ_{₂}_{-T}² indicates the value of this outgoing error function when dividing a day into two segments 0−t₂ and t₂−T. T is the number of sampling points, when sampling in hours, T=24; when sampling in quarters, T=96.

The minimum value of this output error function for a time division number of 2 is

$${F}_{min}^{2} = {min}_{{t}_{2} = 1 , 2 , ⋯ , T - 1} {F}_{0 - {t}_{2} - T}^{2} \qquad ( 10 )$$

Assuming that the time slot split node corresponding to Fₘᵢₙ² is t₂*, the day is divided into 2 time slots, noted as (0−t₂*, t₂*−T), after the first level of splitting. On this basis, traversing the moments within 0−t₂* and t₂*−T, two types of cases occur since t₃ may be located within 0−t₂* or t₂*−T. (0−t₂*, t₂*−t₃, t₃−T) or (0−t₃, t₃−t₂*, t₂*−T), when the optimal split node is determined according to the following equation.

$${F}_{min}^{3} = min \{ \begin{matrix}{min}_{{t}_{3} = 1 , 2 , ⋯ , {t}_{2}^{*} - 1} {F}_{0 - {t}_{3} - {t}_{2}^{*} - T}^{3} \\ {min}_{{t}_{3} = {t}_{2}^{*} + 1 , ⋯ , T - 1} {F}_{0 - {t}_{2}^{*} - {t}_{3} - T}^{3}\end{matrix} \} \qquad ( 11 )$$

Assuming that the time slot split nodes corresponding to Fₘᵢₙ³ are t₂* and t₃* in order, the day is divided into 3 time slots after the second level of splitting, which is noted as (0−t₂*, t₂*−t₃*, t₃*−T). Repeat the above process until the number of time periods is T. Through the whole process of hierarchical splitting, the optimal splitting node and the corresponding minimum value [Fₘᵢₙ¹, Fₘᵢₙ², . . . , Fₘᵢₙ^{T}] of this outgoing error function can be found for various number of time period divisions.

Based on the above results, the two-dimensional relationship between the output error function and the number of time slots is plotted. The larger the number of time slots, the smaller the output error function, which means that the probability density distribution function is more accurate, but the increase of the number of segments will increase the computational effort of power system simulation, so it is very important to choose the appropriate number of time slots.

To determine the optimal number of time slots, the concept of economic efficiency is introduced. Typically, the benefit is the difference between revenue and cost. In the present invention, the degree of reduction of this output error function is the revenue, and the degree of increase in the number of time slots divided is the cost. The calculation formula is as follows.

$${ε}_{n} = \frac{{F}_{max} - {F}_{min}^{n}}{{F}_{max} - {F}_{min}} {δ}_{n} = \frac{n - {n}_{min}}{{n}_{max} - {n}_{min}} \qquad ( 12 )$$

where εₙ indicates the degree of decrease of this output error function when the number of time slots is n; δₙ indicates the degree of increase of the number of time slots when the number of time slots is n; Fₘₐₓ and Fₘᵢₙ indicate the maximum and minimum values of this output error function, Fₘₐₓ=max(Fₘᵢₙ¹, Fₘᵢₙ², . . . , Fₘᵢₙ^{T}), Fₘᵢₙ=min(Fₘᵢₙ¹, Fₘᵢₙ² . . . , Fₘᵢₙ^{T}), respectively; nₘₐₓ and nₘᵢₙ indicate the maximum and minimum values of the number of time slots, nₘₐₓ=T, nₘᵢₙ=1, respectively.

The formula for calculating the benefits is as follows.

eₙ=εₙ−δₙ (13)

Find the number of time period n* corresponding to the maximum benefit as the final number of time period. When the number of time periods is less than n*, the output error function is small and obvious; when the number of time periods is greater than n*, the output error function tends to be stable, so n*is the appropriate number of time periods to divide, and its schematic diagram is shown in FIG. 3.

The non-parametric method is employed to establish the probability distribution of the power output of the wind and solar power cluster for each time period. Kernel density estimation, a nonparametric method used to estimate the probability density function, x₁, x₂, . . . , xₙ is n samples of the random variable X, and let its probability density function ƒₕ (x) be.

$${f}_{h} ( x ) = \frac{1}{nh} {\sum }_{i = 1}^{n} K ( \frac{x - {x}_{i}}{h} ) \qquad ( 14 )$$

where h is the smoothing parameter, also known as the bandwidth; K [symbol] is the kernel function, and the most commonly used Gaussian kernel function is chosen for this invention. Mathematical theory proves that ƒₕ (x) will inherit the continuity and differentiability of K(D), and if the Gaussian kernel function is chosen, ƒₕ(x) can be differentiated of arbitrary order.

The n samples p₁, p₂, . . . , pₙ of the output rate P_{t,d} of the wind and solar power plant group are brought into the above equation to derive the probability density function ƒₕ(p) of the output of the corresponding wind and solar power plant group. The integration operation of ƒₕ (p) is carried out to further obtain the cumulative probability distribution Fₚ of the output of the wind and solar power cluster output as follows.

Fₚ=∫₀^{p}ƒₕ(p)dp (15)

According to the cumulative probability distribution Fₚ, the possible variation interval of the output value of the wind and solar power cluster under different confidence levels can be found.

The method is now validated with 21 wind and photovoltaic stations in a region of Yunnan, where the actual and planned output data from 2017-2018 are used to construct the model, and the data from January 2019 are used for testing, with a time scale of 15 min. Considering the characteristics of PV plant night stop and day hair, the data from 8:00 to 19:00 are extracted for analysis. To verify the applicability of the method of the invention to different power plant groups, three power plant group hybrid schemes are constructed, scheme 1 for a single wind power plant group, scheme 2 for a single PV power plant group, and scheme 3 for a hybrid cluster of wind and solar power plants. Scheme 1 includes four wind power plant clusters, Scheme 2 includes three photovoltaic power plant clusters, and Scheme 3 includes five mixed wind and landscape power plant clusters.

The sample data were processed into D×T dimensional matrices (D is the number of days and T is daily sampling point), and the three scenarios were divided into time periods separately using the method above, and the results are shown in Table 1. In general, the power output time periods among the clusters of the schemes show similar results. For the purpose of description, the results of scheme 1 segmentation are recorded as 0:00-8:00-15:00-24:00, indicating that the differences in wind power output characteristics are mainly reflected in three time periods. The segmentation result of scheme 2 is 3 segments, i.e. 8:00-10:00-17:00-19:00, which is basically consistent with the intra-day power generation law of PV plants, i.e. small in the early morning and evening and large in the midday. Scheme 3 is influenced by the different power generation characteristics of the wind and solar power plant, and the daily output process division differs greatly from the first two schemes, and the clusters 1, 2, 3 and clusters 4 and 5 within the scheme also show a large variation in output between them.

The non-parametric kernel density estimation method is used to establish the probability distribution of power output for each time period of each power station group. Based on the probability density distribution of power output, the variation interval of power output under different confidence levels can be analyzed, and then the accuracy of the distribution law can be evaluated. The first is to evaluate whether the probability distribution is reliable, expressed by the probability of the actual value falling into the interval of the output change; the second is to analyze the concentration of the probability distribution, i.e., the width of the interval, the narrower the interval, the more concentrated the uncertainty information and the stronger the utility.

The confidence interval is selected based on the principle of minimum width, and assuming that the upper and lower confidence intervals for the output of each time period are [p̅₁, p̅₂, . . . , p̅_{T}] and [p₁, p₂, . . . , p_{T}], respectively, the average interval width is.

$$d = \frac{1}{T} {\sum }_{t = 1}^{T} ( {\overline{p}}_{t} - {\underline{p}}_{t} ) \qquad ( 16 )$$

where d indicates the width of the mean interval; p̅ₜ, P indicate the upper and lower confidence interval limits of time period t, respectively.

Reliability is calculated using equation (13).

$${R}_{1 - β} = \frac{{n}_{1 - β}}{N} \times 100 \% \qquad ( 17 )$$

where R_{1-β} is the reliability value at confidence level 1−β; N is the number of samples; n_{1-β} is the number of actual output values falling into the confidence interval with confidence level 1−β. The closer R_{1-β}, is to 1, the higher the reliability is indicated.

Due to the large number of power station clusters, the following focuses on selecting typical power station clusters 4, 1 and 1 in schemes 1, 2 and 3 for evaluation and analysis. For convenience, the method of the present invention is noted as Method 1 and is compared with a single probability distribution function model, noted as Method 2.

FIGS. 4(a) and 4(b) give the relationship between the different confidence levels of the wind power plant group and the reliability of the output description and the width of the average interval. It can be seen that Method 1 has higher reliability, with 99.3% reliability at 90% confidence interval, and the capacity variation interval of Method 1 is smaller, which indicates that the time-of-day treatment reduces the uncertainty of capacity and helps to reduce the flexible capacity requirement of the grid.

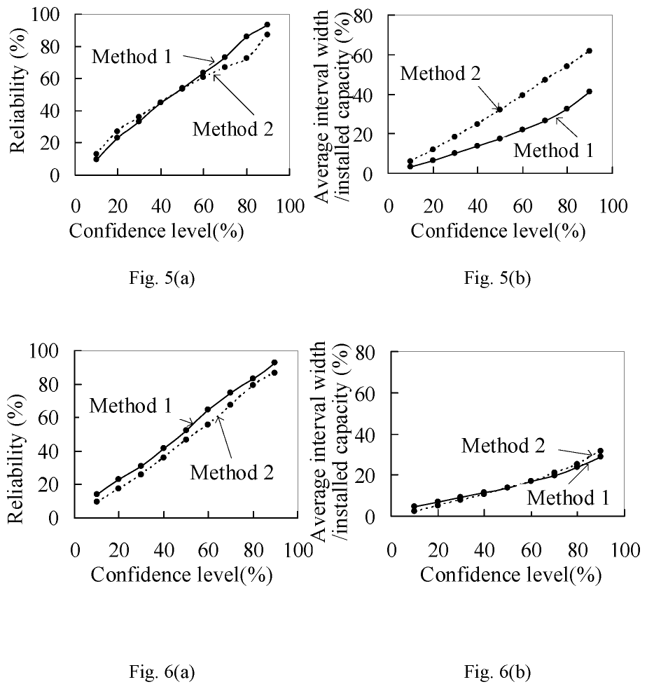

FIGS. 5(a) and 5(b) give the relationship between different confidence levels of the PV plant group and the reliability of the output description and the width of the average interval. Unlike the wind power plant group obviously, the reliability of the two methods is similar overall, and the average interval width of method 2 is the largest, which indicates that the PV plant has a large difference in the timing output pattern, i.e., there is a time-varying characteristic.

FIGS. 6(a) and 6(b) give the relationship between different confidence levels and output description reliability and average interval width of the wind and solar hybrid power plant group. It can be seen that the average interval widths of Method 1 and Method 2 are similar, mainly due to the complementary power output of wind and solar power plants, which makes the power output of the hybrid power plant group less volatile and the time-varying characteristics weaker.

Through the comparative analysis of different methods and schemes, it is verified that the wind and solar power plant group output description method proposed in this invention considering time-varying characteristics can be applied to different kinds of power plants, and the reliability of the results is high and uncertainty is small, which improves the accuracy of the model while ensuring the smaller scale of the wind and solar uncertainty output model.

TABLE 1
Results of time division

| | | Number of | |
|---|---|---|---|
| Scheme | Cluster | periods | Results of the time period |
| Scheme | Cluster 1 | 3 | 0:00-8:00-15:00-24:00 |
| 1 | Cluster 2 | 3 | 0:00-8:00-15:00-24:00 |
| | Cluster 3 | 3 | 0:00-8:00-14:00-24:00 |
| | Cluster 4 | 3 | 0:00-8:00-15:00-24:00 |
| Scheme | Cluster 1 | 3 | 8:00-10:00-17:00-19:00 |
| 2 | Cluster 2 | 3 | 8:00-10:00-17:00-19:00 |
| | Cluster 3 | 3 | 8:00-10:00-17:00-19:00 |
| Scheme | Cluster 1 | 4 | 0:00-6:00-11:00-19:00-24:00 |
| 3 | Cluster 2 | 4 | 0:00-5:00-11:00-19:00-24:00 |
| | Cluster 3 | 4 | 0:00-6:00-12:00-18:00-24:00 |
| | Cluster 4 | 4 | 0:00-8:00-12:00-19:00-24:00 |
| | Cluster 5 | 4 | 0:00-8:00-13:00-18:00-24:00 |

1. A method for describing power output of a cluster of wind and solar power stations considering time-varying characteristics, wherein comprising the following steps:
(1) for the problem of dividing a time period of a daily output process of a group of wind and solar power plants, an output error function is used as the evaluation criterion for the time period division, so that output characteristics of the group of wind and solar power plants in the same time period tend to be consistent, and a calculation formula is as follows:
$$\{ \begin{matrix}F = {\sum }_{k = 1}^{K} {F}_{{t}_{k - 1} , {t}_{k}} \\ {F}_{{t}_{k - 1} , {t}_{k}} = {{\sum }_{t = {t}_{k - 1}}}^{{t}_{k}} {{\sum }_{d = 1}}^{D} {( {p}_{t , d} - {p}_{d , {t}_{k - 1} - {t}_{k}}^{avg} )}^{2} / D \\ {p}_{d , {t}_{k - 1} - {t}_{k}}^{avg} = \frac{1}{{l}_{k}} {{\sum }_{t = {t}_{k - 1}}}^{{t}_{k}} {p}_{t , d} \\ {p}_{t , d} = \frac{{P}_{t , d}}{{P}_{C}}\end{matrix} ; \qquad ( 1 )$$
where: F indicates a value of the output error function, a larger the value of the output error function, a worse the time division effect, a smaller the value of the output error function, a better the time division effect; K is the number of time slots; tₖ₋₁, tₖ indicates the node of a time interval division; Fₜ_{_{k−1,}}ₜ_{ₖ} indicates a sum of squared errors in a output data of the group of wind and solar power plants at each moment in time period tₖ₋₁, tₖ a larger Fₜ_{_{k−1,}}ₜ_{ₖ}, indicates a larger difference in the output data of the group of wind and solar power plants in that time period, and vice versa; D is a total number of days of the extracted wind and solar power plant group output data; d indicates the d th day; P_{t,d} indicates a output rate of a cluster of wind and solar power plants at a tth moment of the d th day; P_{d,t}_{_{k−1}}₋ₜ_{ₖ}^{avg} indicates an average value of the output rate of the wind and solar power plant group at each moment in time period tₖ₋₁−tₖ on the d th day; lₖ indicates a number of sampling points in time period tₖ₋₁−tₖ; P_{t,d} indicates a output of the cluster of wind and solar power plants at the tth moment of the d th day, MW; P_{c} is a total installed capacity of the cluster of wind and solar power plants, MW;
(2) for a problem of optimal splitting nodes under a number of daily power output process of the wind and solar power plant group at any time division, a splitting hierarchical clustering-based time division method is constructed, and an actual power output process of each wind and solar power plant group is used as the characteristic input, and an optimal time division is determined by hierarchical splitting with this power output error function as the evaluation criterion; the specific steps are as follows:
step 1. inputting the actual power output process sequence of each wind and solar power plant cluster;
step 2. iterating through the output of each time period in a day, divide the 24 h of the day into two segments, and calculate the value of this output error function corresponding to all time nodes according to Equation (1), and the result is expressed as the following equation;
[F_{0-1-T}²,F_{0-2-T}², . . . F₀₋ₜ_{₂}_{-T}², . . . F_{0-(T-1)-T}²];
where F₀₋ₜ_{₂}_{-T}² indicates the value of this outgoing error function when dividing a day into two segments 0−t₂ and t₂−T; T is the number of sampling points, when sampling in hours, T=24; when sampling in quarters, T=96;
step 3. identifying a minimum value of this output error function when divided into 2 time periods;
$${F}_{min}^{2} = {min}_{{t}_{2} = 1 , 2 , ⋯ , T - 1} {F}_{0 - {t}_{2} - T}^{2} ;$$
assuming that a time slot split node corresponding to Fₘᵢₙ² is t₂, the day is divided into 2 segments, noted as (0−t₂*, t₂*−T), after a first level of splitting;
step 4. Traversing 0−t₂* and t₂*−T within each time out, because t₃ may be located in 0−t₂* or time t₂*−T, so there will be two types of cases: (0−t₂*, t₂*−t₃, t₃−T) or (0−t₃, t₃−t₂*, t₂*−T), then determine an optimal split node according to the following formula:
$${F}_{min}^{3} = min \{ \begin{matrix}{min}_{{t}_{3} = 1 , 2 , ⋯ , {t}_{2}^{*} - 1} {F}_{0 - {t}_{3} - {t}_{2}^{*} - T}^{3} \\ {min}_{{t}_{3} = {t}_{2}^{*} + 1 , ⋯ , T - 1} {F}_{0 - {t}_{2}^{*} - {t}_{3} - T}^{3}\end{matrix} \} ;$$
assuming that the time slot split nodes corresponding to Fₘᵢₙ³ are t₂* and t₃* in that order, a day is divided into 3 segments, noted as (0−t₂*, t₂*−t₃*−T), after a second level of splitting;
step 5. in accordance with step 4, the optimal segmentation nodes and a corresponding minimum value of this output error function [Fₘᵢₙ¹, Fₘᵢₙ², Fₘᵢₙ^{T}] under different time period division quantities are obtained in turn, until a maximum time period division quantity reaches T;
(3) to determine an optimal number of time slots for the daily output process of the wind and solar power plant group, the output efficiency index is used as a criterion, and a number of time slots corresponding to the maximum output efficiency index is taken as a final number of time slots; a specific steps are as follows:
step 1. defining revenue as a degree of reduction of this output error function and cost as a degree of increase of the time slot division quantity, calculated as follows:
$$\begin{matrix}{ε}_{n} = \frac{{F}_{max} - {F}_{min}^{n}}{{F}_{max} - {F}_{min}} \\ {δ}_{n} = \frac{n - {n}_{min}}{{n}_{max} - {n}_{min}}\end{matrix} ;$$
where: εₙ denotes the degree of reduction of this output error function when the number of time slots is n; δₙ denotes the degree of increase in the number of time slots when the number of time slots is n; Fₘₐₓ and Fₘᵢₙ indicate the maximum and minimum values of this outgoing output error function Fₘₐₓ=max(Fₘᵢₙ¹, Fₘᵢₙ², . . . , Fₘᵢₙ^{T}), Fₘᵢₙ=min(Fₘᵢₙ¹, Fₘᵢₙ² . . . , Fₘᵢₙ^{T}), respectively; nₘₐₓ and nₘᵢₙ indicate the maximum and minimum values of the number of time periods divided nₘₐₓ=T, nₘᵢₙ=1, respectively;
step 2. calculating the benefits under different time division quantities of the daily output process of the wind and solar power plant cluster according to the revenue and cost, the formula is as follows:
eₙ=εₙ−δₙ;
step 3. identifying the number of time slots corresponding to the maximum benefit n* as the final number of time slots;
(4) to establish the probability distribution of power output for each time period of the wind and solar power plant group by using the kernel density estimation method for a problem of uncertain power output description of the wind and solar power plant group; this method is a nonparametric method used to estimate the probability density function, x₁, x₂, . . . , xₙ for n samples of the random variable X let its probability density function be ƒₕ(x):
$${f}_{h} ( x ) = \frac{1}{nh} {\sum }_{i = 1}^{n} K ( \frac{x - {x}_{i}}{h} ) ; \qquad ( 2 )$$
where: h is a smoothing parameter, also known as the bandwidth; K(·) is a kernel function, and the most commonly used Gaussian kernel function is chosen; mathematical theory demonstrates that ƒₕ(x) will inherit the continuity and differentiability of (·); if the Gaussian kernel function is chosen, then ƒₕ(x) can be differentiated to any order; n samples p1, p2, . . . , pn of the output rate P_{t,d} of the cluster of wind and solar power plants are brought into the above equation (2) to derive the corresponding probability density function ƒₕ(P) of the output of the cluster of wind and solar power plants;
a cumulative probability distribution Fₚ of the output of the cluster of wind and solar power plants is obtained by integrating ƒₕ(p), as follows:
Fₚ=∫₀^{p}ƒₕ(p)dp;
according to the cumulative probability distribution Fₚ, the possible variation interval of the output power of the wind and solar power plant group under different confidence levels is found.
